(19) United States
(12) Patent Application Publication
(10) Pub. No.: US 2026/0242967 A1
(43) Pub. Date: Aug. 20, 2026

(54) METHOD FOR PRODUCING ELECTRODE CATALYST INCLUDING NITROGEN-CONTAINING CARBON MATERIAL AND SOLID-ELECTROLYTE ELECTROLYTIC DEVICE

(71) Applicants: IDEMITSU KOSAN CO.,LTD., Chiyoda-ku, Tokyo (JP); THE UNIVERSITY OF OSAKA, Suita-shi, Osaka (JP)

(72) Inventors: Rino NISHIDA, Chiyoda-ku, Tokyo (JP); Qingxin JIA, Chiyoda-ku, Tokyo (JP); Hiroyuki KANEKO, Chiyoda-ku, Tokyo (JP); Kazuhide KAMIYA, Suita-shi, Osaka (JP)

(73) Assignees: IDEMITSU KOSAN CO.,LTD., Chiyoda-ku, Tokyo (JP); THE UNIVERSITY OF OSAKA, Suita-shi, Osaka (JP)

(21) Appl. No.: 19/162,340

(22) PCT Filed: Feb. 9, 2024
(86) PCT No.: PCT/JP2024/004451

§ 371 Date: Sep. 4, 2025

(30) Foreign Application Priority Data
Mar. 7, 2023 (JP) 2023-035002

(51) Int. Cl. C25B 11/054; C25B 9/23; C25B 11/032; C25B 11/057; C25B 11/075

(52) U.S. Cl. CPC C25B 11/054; C25B 9/23; C25B 11/032; C25B 11/057; C25B 11/075

(57) ABSTRACT

The present disclosure provides a method of producing a catalyst for producing an electrode catalyst containing a nitrogen-containing carbon material.

### TECHNICAL FIELD

The technology of the present disclosure relates to a method of producing an electrode catalyst including a nitrogen-containing carbon material and to a solid electrolyte type electrolysis device.

### BACKGROUND ART

Carbon dioxide is emitted when energy is extracted from fossil fuel and the like. An increase in concentration of carbon dioxide in the atmosphere is said to be one of the causes of global warming. Carbon dioxide is an extremely stable substance, and hence there have hitherto been very few ways to utilize carbon dioxide. However, in an era when global warming is becoming more serious, there has been a demand for a new technology for converting carbon dioxide into another substance to recycle the substance as a resource. For example, a carbon dioxide reduction device capable of directly reducing carbon dioxide in a gas phase is being developed.

Among carbon dioxide reduction devices, a polymer electrolyte type electrolysis device that utilizes a polymer electrolyte has attracted attention because the polymer electrolyte electrolysis device can directly reduce carbon dioxide in a gas phase and can sufficiently decrease the resistance to ion movement through use of a thin-film polymer electrolyte. A cathode for carbon dioxide reduction generally contains a mixture of catalyst fine particles, a conductive carrier, and an ion exchange resin, and various researches have been conducted on those components.

As a catalyst, fine particles of a metal, such as gold or silver, are widely used. However, from the viewpoints of a resource amount, cost, and the like, a catalyst formed of a nitrogen-containing carbon-based material in which a metal is coordinated by nitrogen and supported on the carbon-based material has been developed as an alternative catalyst and is considered to be promising (e.g., see NPL 1).

In NPL 1, a catalyst is synthesized by calcining nickel acetate, 1,10-phenanthroline, and carbon black at 600° C. for 2 hours.

In addition, in NPL 2, there is a disclosure of a method of synthesizing a nitrogen-containing carbon-based material by dispersing nickel chloride, pentaethylenehexamine, and graphene oxide in ethanol, evaporating the solvent, and then calcining the resultant at 900° C. for 45 seconds.

### CITATION LIST

### Non Patent Literature

NPL 1: Hongzhou Yang, Lu Shang, Qinghua Zhang, Run Shi, Geoffrey I. N. Waterhouse, Lin Gu & Tierui Zhang, Nature Communications, volume 10, Article number: 4585 (2019)
NPL 2: Panpan Su, Kazuyuki Iwase, Shuji Nakanishi, Kazuhito Hashimoto, and Kazuhide Kamiya, Small, 2016, 12, 44, 6083-6089

### SUMMARY OF INVENTION

### Technical Problem

In the catalyst synthesis method disclosed in NPL 1, the calcination time is set to a long period of time of 2 hours in order to produce a highly active catalyst. When the calcination time is shorter than 2 hours, active sites are not sufficiently formed. However, when the calcination time is extended for a long period of time, the aggregation of nickel (Ni) is advanced. In addition, when pentaethylenehexamine is used as in the catalyst synthesis method disclosed in NPL 2, the aggregation of nickel is rapidly advanced because the decomposition temperature of pentaethylenehexamine is low. The aggregated nickel has no CO₂ reduction activity and advances the generation of H₂, and hence it was required to remove the nickel aggregate by washing the catalyst with sulfuric acid after calcination and use the resultant as a catalyst. The washing with sulfuric acid may wash away most of the nickel loaded during catalyst synthesis. As described above, in the catalyst synthesis methods disclosed in NPLs 1 and 2, the aggregation of nickel is liable to be advanced, and hence the supported amount of nickel supported in a highly dispersed state, which serves as an active site, becomes small.

The technology of the present disclosure has been made in view of the above-mentioned circumstances, and an object of the technology of the present disclosure is to provide technologies related to a method of producing a catalyst in which a supported amount of a catalyst source on a carrier can be increased, to a cathode that contains a catalyst having a large supported amount of a catalyst source on a carrier and has high electrolysis activity, to an ion exchange membrane-electrode assembly, and to a solid electrolyte type electrolysis device, and the technology of the present disclosure aims to achieve the object.

### Solution to Problem

<1> A method of producing a catalyst for producing an electrode catalyst including a nitrogen-containing carbon material, including: a mixing step of mixing a carbon-containing carrier, a nickel compound, and a nitrogen-containing compound having 1 to 6 heterocycles each having 5 to 14 ring-forming atoms and at least two nitrogen atoms; and a calcination step of calcining the mixture obtained in the mixing step for a calcination time of 10 seconds or more and 1 hour or less.
<2> A method of producing a catalyst for producing an electrode catalyst including a nitrogen-containing carbon material, including: a mixing step of mixing a carbon-containing carrier, a nickel compound, and a nitrogen-containing compound having 1 to 6 heterocycles each having 5 to 14 ring-forming atoms, at least two nitrogen atoms, and a nickel ion; and a calcination step of calcining the mixture obtained in the mixing step for a calcination time of 10 seconds or more and 1 hour or less.
<3> The method of producing a catalyst according to Item <1> or <2>, wherein the calcination step includes calcining the mixture at 550° C. or more and less than 1,000° C.
<4> The method of producing a catalyst according to any one of Items <1> to <3>, wherein the nitrogen-containing compound has a pyridine ring, a pyrrole ring, or an isoindole ring.
<5> The method of producing a catalyst according to any one of Items <1> to <4>, wherein the calcination time is 30 minutes or less.
<6> The method of producing a catalyst according to any one of Items <1> to <5>, wherein the calcination time is 1 minute or less.
<7> A cathode, including: a catalyst layer containing an electrode catalyst produced by the method of producing a catalyst of any one of Items <1> to <6>; and a gas diffusion layer.
<8> An ion exchange membrane-electrode assembly, including the cathode of Item <7>, a solid electrolyte, and an anode.
<9> The ion exchange membrane-electrode assembly according to Item <8>, wherein the solid electrolyte is an anion exchange membrane.
<10> A solid electrolyte type electrolysis device, including:
the cathode of Item <7>;
an anode forming a pair of electrodes with the cathode;
a solid electrolyte interposed between the cathode and the anode in a contact state; and
a voltage application unit configured to apply a voltage between the cathode and the anode.
<11> The solid electrolyte type electrolysis device according to Item <10>, wherein the solid electrolyte is an anion exchange membrane.

### Advantageous Effects of Invention

According to the technology of the present disclosure, technologies related to the method of producing a catalyst in which a supported amount of a catalyst source on a carrier can be increased, to the cathode that contains a catalyst having a large supported amount of a catalyst source on a carrier and has high electrolysis activity, to the ion exchange membrane-electrode assembly, and to the solid electrolyte type electrolysis device can be provided.

### BRIEF DESCRIPTION OF DRAWINGS

FIG. 1 is a schematic view of an ion exchange membrane-electrode assembly to be suitably used in an embodiment of the present disclosure.

FIG. 2 is a schematic view of a solid electrolyte type electrolysis device to be suitably used in an embodiment of the present disclosure.

### DESCRIPTION OF EMBODIMENTS

The upper limit values and lower limit values of numerical ranges described herein may be freely combined. For example, when the range of “from A to B” and the range of “from C to D” are described as numerical ranges, the numerical range of “from A to D” and the numerical range of “from C to B” are also included in the scope of the present disclosure.

In addition, the numerical range of “from a lower limit value to an upper limit value” described herein means that a value is the lower limit value or more and the upper limit value or less unless otherwise stated.

### <Method of Producing Catalyst>

A method of producing a catalyst according to a first embodiment of the present disclosure is a method of producing an electrode catalyst including a nitrogen-containing carbon material, the method including: a mixing step of mixing a carbon-containing carrier, a nickel compound, and a nitrogen-containing compound having 1 to 6 heterocycles each having 5 to 14 ring-forming atoms and at least two nitrogen atoms; and a calcination step of calcining the mixture obtained in the mixing step for a calcination time of 10 seconds or more and 1 hour or less.

A method of producing a catalyst according to a second embodiment of the present disclosure is a method of producing an electrode catalyst including a nitrogen-containing carbon material, the method including: a mixing step of mixing a carbon-containing carrier, a nickel compound, and a nitrogen-containing compound having 1 to 6 heterocycles each having 5 to 14 ring-forming atoms, at least two nitrogen atoms, and a nickel ion; and a calcination step of calcining the mixture obtained in the mixing step for a calcination time of 10 seconds or more and 1 hour or less.

The method of producing a catalyst according to the first embodiment of the present disclosure and the method of producing a catalyst according to the second embodiment of the present disclosure are sometimes collectively simply referred to as “method of producing a catalyst according to the embodiment of the present disclosure.”

In addition, the mixing step in the method of producing a catalyst according to the first embodiment of the present disclosure is sometimes referred to as “mixing step (1).” The mixing step in the method of producing a catalyst according to the second embodiment of the present disclosure is sometimes referred to as “mixing step (2).” The mixing step (1) and the mixing step (2) are sometimes collectively simply referred to as “mixing step according to the embodiment of the present disclosure.”

The “nitrogen-containing compound having 1 to 6 heterocycles each having 5 to 14 ring-forming atoms and at least two nitrogen atoms” used in the mixing step (1) is sometimes simply referred to as “nitrogen-containing heterocyclic compound (1).”

The “nitrogen-containing compound having 1 to 6 heterocycles each having 5 to 14 ring-forming atoms, at least two nitrogen atoms, and a nickel ion” used in the mixing step (2) is sometimes simply referred to as “nitrogen-containing heterocyclic compound (2).”

The nitrogen-containing heterocyclic compound (1) and the nitrogen-containing heterocyclic compound (2) are sometimes collectively simply referred to as “nitrogen-containing heterocyclic compound according to the embodiment of the present disclosure.”

The electrode catalyst produced by the method of producing a catalyst according to the embodiment of the present disclosure is sometimes simply referred to as “catalyst”.

The method of producing a catalyst according to the embodiment of the present disclosure may further include a washing step, a pulverizing step, a covering step, and the like in addition to the above-mentioned mixing step and calcination step.

The catalyst produced by the method of producing a catalyst according to the embodiment of the present disclosure has a form in which nickel derived from a nickel compound is supported on a carrier by a nitrogen-containing compound. In the catalyst according to the embodiment of the present disclosure, the component that exhibits a catalytic action in the reduction reaction of carbon dioxide is the above-mentioned nickel, but in the technology of the present disclosure, the configuration including the nickel coordinated by a nitrogen atom derived from a nitrogen-containing compound and the carrier is referred to as “catalyst”. In addition, nickel, which is the component that exhibits a catalytic action, is referred to as “catalyst source.” Nickel exhibits a catalytic action, for example, by forming a complex with a nitrogen-containing compound.

The catalyst obtained by the method of producing a catalyst according to the embodiment of the present disclosure has the above-mentioned configuration and hence can suppress a nickel aggregate and increase the supported amount of a catalyst source (nickel) on the carrier. The foregoing is presumed to be based on the following reasons.

In the mixing step (1), the nitrogen-containing heterocyclic compound (1), a nickel compound containing a nickel ion serving as a catalyst source, and a carbon-containing carrier are mixed. In the mixing step (2), the nitrogen-containing heterocyclic compound (2) containing a nickel ion serving as a catalyst source and a carbon-containing carrier are mixed.

The nitrogen-containing heterocyclic compound has a decomposition temperature higher than that of pentaethylenehexamine. Thus, it is conceived that the nitrogen-containing heterocyclic compound is less liable to be thermally decomposed by heating in the calcination step, and the aggregation of nickel is suppressed. In addition, it is conceived that the aggregation of nickel can be suppressed also by shortening the calcination time to 1 hour or less. As a result, it is conceived that the supported amount of non-aggregated nickel on the carrier can be increased.

The mixing step and the calcination step according to the embodiment of the present disclosure are described in detail below, and then a cathode, an ion exchange membrane-electrode assembly, and an electrolysis device are described in the stated order.

First, the mixing step is described.

### [Mixing Step]

In the mixing step (1), a carbon-containing carrier, a nickel compound, and a nitrogen-containing compound having 1 to 6 heterocycles each having 5 to 14 ring-forming atoms and at least two nitrogen atoms [nitrogen-containing heterocyclic compound (1)] are mixed.

In the mixing step (2), a carbon-containing carrier and a nitrogen-containing compound having 1 to 6 heterocycles each having 5 to 14 ring-forming atoms, at least two nitrogen atoms, and a nickel ion [nitrogen-containing heterocyclic compound (2)] are mixed.

In the mixing step according to the embodiment of the present disclosure, a solvent may be further blended in order to efficiently perform the mixing of each of the components.

### [Carrier]

The carrier according to the embodiment of the present disclosure contains carbon.

Carbon generally has conductivity, and hence the carrier according to the embodiment of the present disclosure is a conductive carrier.

The carbon-containing carrier is not limited as long as the carrier is a conductive material that can be used as a gas diffusion layer in an electrode arranged in a device for reducing carbon dioxide, and examples thereof include carbons, such as carbon black (e.g., furnace black, acetylene black, Ketjen black, or medium thermal carbon black), activated carbon, graphite, a carbon nanotube, a carbon nanofiber, a carbon nanohorn, a graphene nanoplatelet, and nanoporous carbon. Among them, carbon black is preferred from the viewpoint of improving the active site density.

From the viewpoints of improving the active site density and improving the current density, carbon black has a primary particle diameter of preferably from 5 nm to 200 nm, more preferably from 10 nm to 100 nm, still more preferably from 10 nm to 50 nm. The primary particle diameter of the carbon black may be measured with a transmission electron microscope. The primary particle diameter may be measured by measuring the lengths in the longest direction of particles observed with the microscope as long diameters and calculating an average value of the resultant long diameters.

From the same viewpoints, the secondary particle diameter (particle diameter of an aggregate) of carbon black is preferably small, and carbon black having a large amount of functional groups is preferred.

Carbon black may be a commercially available product, and examples thereof include VULCAN (trademark) XC72 (manufactured by Cabot Corporation), and BLACK PEARLS 2000 (manufactured by Cabot Corporation).

The carriers may be used alone or in combination thereof.

The blending amount of the carrier in the mixing step according to this embodiment is preferably from 0.1 part by mass to 100 parts by mass, more preferably from 0.1 part by mass to 50 parts by mass with respect to 100 parts by mass of a solvent from the viewpoint of dispersing the carrier in a solution.

### [Nickel Compound]

Examples of the nickel compound to be blended in the mixing step (1) include a chloride salt, a nitrate salt, and a sulfate salt each containing a nickel ion, and the nickel compound may also be a hydrate.

Specific examples thereof include nickel (II) chloride hexahydrate and nickel (II) nitrate hexahydrate.

In the mixing step according to this embodiment, the nickel compounds may be used alone or in combination thereof.

The blending amount of the nickel compound in the mixing step according to this embodiment is preferably from 1 part by mass to 80 parts by mass, more preferably from 3 parts by mass to 60 parts by mass with respect to 100 parts by mass of the carrier.

### [Nitrogen-Containing Compound]

Among the nitrogen-containing compounds according to this embodiment (nitrogen-containing heterocyclic compounds according to the embodiment of the present disclosure), the nitrogen-containing heterocyclic compound (1) has 1 to 6 heterocycles each having 5 to 14 ring-forming atoms and at least two nitrogen atoms. The nitrogen-containing heterocyclic compound (2) has 1 to 6 heterocycles each having 5 to 14 ring-forming atoms, at least two nitrogen atoms, and a nickel ion.

The nitrogen-containing heterocyclic compound (1) and the nitrogen-containing heterocyclic compound (2) are different from each other only in that the former (1) is free of a nickel ion and the latter (2) contains a nickel ion, and both have the same structure having 1 to 6 heterocycles each having 5 to 14 ring-forming atoms and at least two nitrogen atoms.

The nitrogen-containing heterocyclic compound (2) may be used as a complex in which a nickel ion is bonded to the nitrogen-containing heterocyclic compound (1) through a coordinate bond.

The phrase “having at least two nitrogen atoms” means that the nitrogen-containing heterocyclic compound according to the embodiment of the present disclosure as a whole has two or more nitrogen atoms.

The nitrogen-containing heterocyclic compound may have: a form (a) including one heterocycle having two or more nitrogen atoms as ring-forming hetero atoms; a form (b) including a plurality of heterocycles each having one nitrogen atom as a ring-forming hetero atom; or a form (c) including a heterocycle having a hetero atom other than a nitrogen atom, the heterocycle having two or more nitrogen-containing groups each having one nitrogen atom such as an amino group as substituents, or one nitrogen-containing group having two or more nitrogen atoms such as an azo group as a substituent.

From the viewpoint of further suppressing the aggregation of nickel, the nitrogen-containing heterocyclic compound according to the embodiment of the present disclosure is preferably one or more selected from the group consisting of: a compound having one heterocycle having two or more nitrogen atoms as ring-forming hetero atoms; and a compound having a plurality of heterocycles each having one nitrogen atom as a ring-forming hetero atom.

From the viewpoint of further suppressing the aggregation of nickel, the number of nitrogen atoms in the nitrogen-containing heterocyclic compound according to the embodiment of the present disclosure is preferably 20 or less, more preferably 15 or less, still more preferably 10 or less. In addition, from the viewpoint of further increasing the supported amount of non-aggregated nickel on the carrier, the number of nitrogen atoms in the nitrogen-containing heterocyclic compound according to the embodiment of the present disclosure is preferably 2 or more, more preferably 3 or more, still more preferably 4 or more.

The term “heterocycle having 5 to 14 ring-forming atoms” means a ring having, as ring-forming atoms, a carbon atom and a hetero atom, such as a nitrogen atom, an oxygen atom, a sulfur atom, or a silicon atom, and having 5 to 14 ring-forming atoms. The heterocycle may be a condensed ring.

For example, phenanthroline is a condensed ring of two pyridine rings and one benzene ring, and is a heterocycle having 14 ring-forming atoms. In addition, bipyridyl has a structure in which pyridine rings are bonded by a single bond, and is a compound including two heterocycles each having 6 ring-forming atoms.

The hetero atoms for forming the heterocycle preferably include at least a nitrogen atom.

The heterocycle may have a substituent, such as an alkyl group, an aryl group, or a halogen atom.

When the heterocycle has a substituent, the number of the substituents is preferably from 1 to 5, more preferably from 1 to 3. In addition, the alkyl group has preferably 1 to 5 carbon atoms, more preferably 1 to 3 carbon atoms. The aryl group has preferably 5 to 10 carbon atoms, more preferably 6 to 8 carbon atoms.

Specific examples of the heterocycle having 5 to 14 ring-forming atoms include: rings each having only a nitrogen atom as a heteroatom, such as a pyridine ring, a pyrrole ring, an isoindole ring, a pyrazole ring, a pyrazine ring, a pyrimidine ring, a pyridazine ring, a quinoline ring, an isoquinoline ring, a carbazole ring, and a phenanthridine ring; rings each having only a sulfur atom as a heteroatom, such as a thiophene ring and a thianthrene ring; rings each having only an oxygen atom as a heteroatom, such as a furan ring, an isobenzofuran ring, a pyran ring, a chromene ring, and a xanthene ring; rings each having only a silicon atom as a heteroatom, such as a silole ring and a silabenzene ring; and rings each having a plurality of kinds of heteroatoms as heteroatoms, such as an isothiazole ring, a phenoxathiin ring, and a phenothiazine ring.

When the nitrogen-containing heterocyclic compound according to the embodiment of the present disclosure has a plurality of heterocycles, the heterocycles may be the same or different from each other.

Among the above-mentioned heterocycles, the heterocycle having 5 to 14 ring-forming atoms is preferably a ring having only a nitrogen atom as a hetero atom, and a pyridine ring, a pyrrole ring, and an isoindole ring are more preferred.

In other words, the nitrogen-containing heterocyclic compound according to the embodiment of the present disclosure more preferably has a pyridine ring, a pyrrole ring, or an isoindole ring.

Examples of the nitrogen-containing heterocyclic compound (1) having a pyridine ring include 1,10-phenanthroline, 4,4′-dimethyl-2,2′-bipyridyl, and 2,2′-bipyridyl.

An example of the nitrogen-containing heterocyclic compound (1) having a pyrrole ring is 5,10,15,20-tetraphenyl-21H,23H-porphine.

An example of the nitrogen-containing heterocyclic compound (1) having an isoindole ring is phthalocyanine.

An example of the nitrogen-containing heterocyclic compound (2) having a pyrrole ring is 5,10,15,20-tetraphenyl-21H,23H-porphine nickel (II).

An example of the nitrogen-containing heterocyclic compound (2) having an isoindole ring is nickel (II) phthalocyanine.

In the mixing step according to the embodiment of the present disclosure, the nitrogen-containing heterocyclic compounds according to the embodiment of the present disclosure may be used alone or in combination thereof, but are preferably used alone.

From the viewpoint of forming a sufficient amount of a nitrogen ligand on the carrier, the blending amount of the nitrogen-containing heterocyclic compound (1) in the mixing step (1) is preferably from 5 parts by mass to 300 parts by mass, more preferably from 10 parts by mass to 200 parts by mass with respect to 100 parts by mass of the carrier.

From the viewpoint of forming a sufficient amount of the nitrogen ligand on the carrier, the blending amount of the nitrogen-containing heterocyclic compound (2) in the mixing step (2) is preferably from 1 part by mass to 150 parts by mass, more preferably from 30 parts by mass to 130 parts by mass with respect to 100 parts by mass of the carrier.

### [Solvent]

The solvent is preferably a solvent that does not react with the carrier, the nickel compound, or the nitrogen-containing heterocyclic compound according to the embodiment of the present disclosure, and specific examples thereof include an alcohol, water, hexane, toluene, dimethyl sulfoxide, and tetrahydrofuran.

The solvents may be used alone or in combination thereof.

Among them, an alcohol containing ethanol is preferably used.

In the mixing step (1), the carrier, the nickel compound, and the nitrogen-containing heterocyclic compound (1) are mixed to produce a catalyst precursor as a mixture.

In the mixing step (2), the carrier and the nitrogen-containing heterocyclic compound (2) are mixed to produce a catalyst precursor as a mixture.

When a solvent is used in the mixing step according to the embodiment of the present disclosure, a solvent dispersion liquid of the catalyst precursor may be subjected to ultrasonic irradiation for degassing.

### [Calcination Step]

In the calcination step according to this embodiment, the mixture (catalyst precursor) obtained in the mixing step is calcined for a calcination time of 10 seconds or more and 1 hour or less.

The nitrogen-containing heterocyclic compound according to the embodiment of the present disclosure in the mixture is thermally decomposed by the heat of the calcination in the calcination step, and the aggregation of nickel is suppressed. At this time, the aggregation of nickel is also suppressed by setting the calcination time to 10 seconds or more and 1 hour or less.

When a solvent is used in the mixing step according to the embodiment of the present disclosure, the calcination step may be performed in two stages. That is, the catalyst precursor is dried by evaporating the solvent in a solvent dispersion liquid of the catalyst precursor through heating, and the catalyst precursor is further placed in a calcination furnace to be calcined.

When the mixture is calcined, it is preferred that the mixture be placed in a quartz tube, and the inside of the quartz tube be purged with an inert gas such as an argon gas before the mixture is calcined.

The calcination time is preferably 20 seconds or more and 45 minutes or less, more preferably 30 seconds or more and 45 minutes or less, still more preferably 30 seconds or more and 30 minutes or less. The calcination time may be set to 20 minutes or less, may be 10 minutes or less, or may also be 1 minute or less. When the calcination time is shortened, the aggregation of nickel is further suppressed.

In addition, the calcination temperature is preferably 500° C. or more and 1,400° C. or less, more preferably 700° C. or more and 1,200° C. or less, still more preferably 700° C. or more and less than 1,000° C., even more preferably 800° C. or more and less than 1,000° C.

### [Washing Step]

The washing step is a step of washing the catalyst obtained in the calcination step with water, an inorganic acid, or the like.

Ion-exchanged water, pure water, or the like is used as the water. Sulfuric acid is preferably used as the inorganic acid. The inorganic acid is preferably used in a concentration of from 1 mol/L to 3 mol/L (“mol/L” is hereinafter sometimes abbreviated as “M”), and an inorganic acid heated to from 60° C. to 90° C. may be used.

In the washing step, it is preferred that the catalyst be washed with water, then with an inorganic acid, and finally with water again.

The washing step may be repeated a plurality of times. For example, a first washing step may be performed before the pulverizing step, and a second washing step may be performed after the pulverizing step.

### [Pulverizing Step]

The pulverizing step is a step of pulverizing the catalyst obtained in the calcination step.

In the method of producing a catalyst according to the embodiment of the present disclosure, the aggregation of nickel can be suppressed by producing a catalyst precursor through use of the nitrogen-containing heterocyclic compound according to the embodiment of the present disclosure, and the active site density of the catalyst can be improved through the pulverizing step.

In the present disclosure, the term “active site density” means the content (mass %) of the nickel ion coordinated by the nitrogen atom in the catalyst.

The calcined product may be pulverized with, for example, balls made of zirconia or alumina. The diameter of each of the balls is preferably from 0.05 mm to 5 mm, and the pulverization conditions are preferably set to from 400 rpm to 1,100 rpm and from 2 minutes to 20 hours.

### [Covering Step]

The covering step is a step of covering the catalyst produced through the calcination step with an ionomer.

When the catalyst is covered with the ionomer, an ion conductive channel between the covered catalyst and a solid electrolyte to be described later is easily formed to facilitate the movement of an ion generated by the reaction, and thus the electrolysis efficiency can be improved.

The details of the ionomer are described later.

It is preferred that the nickel ion in the catalyst produced by the method of producing a catalyst according to the embodiment of the present disclosure be present in a monoatomic state and be in a form of being supported on a carrier by being coordinated by a nitrogen atom.

The content of the nickel ion coordinated by the nitrogen atom may be determined as described below.

The composition ratio (Ni/C) of a nickel ion bonded to (coordinated by) a nitrogen atom to carbon in the catalyst may be measured by X-ray photoelectron spectroscopy (XPS). Narrow scan measurement is performed for each element, and the composition ratio may be determined from the area of each peak.

A nickel fine particle does not serve as an active site, and nickel is present as an aggregate.

### <Cathode>

A cathode according to an embodiment of the present disclosure includes: a catalyst layer containing an electrode catalyst produced by the method of producing a catalyst according to the embodiment of the present disclosure; and a gas diffusion layer.

The cathode according to the embodiment of the present disclosure has high electrolysis activity by including a catalyst layer containing an electrode catalyst produced by the method of producing a catalyst according to the embodiment of the present disclosure.

### [Catalyst Layer]

The catalyst layer contains at least an electrode catalyst produced by the method of producing a catalyst according to the embodiment of the present disclosure, and may further contain an ionomer.

The ionomer functions as a binder resin in the catalyst layer, is a matrix resin (continuous phase) capable of dispersing and fixing the catalyst according to the embodiment of the present disclosure, and also has a function to transfer an ion generated by electrolysis to improve the electrolysis efficiency of CO₂. In addition, the ionomer is preferably conductive, more preferably a polymer electrolyte from the viewpoint of improving the transfer efficiency of the ion generated by electrolysis. It is still more preferred that the polymer electrolyte be an ion exchange resin. The ion exchange resin may be a cation exchange resin or an anion exchange resin, but is preferably an anion exchange resin.

In particular, when the anion exchange resin is used, the anion exchange resin itself has the ability to adsorb carbon dioxide. Along with the ease of ion transfer of the ion exchange resin, the electrolysis efficiency of carbon dioxide can be significantly improved.

Examples of the cation exchange resin include a fluororesin having a sulfone group, and a styrene-divinylbenzene copolymer having a sulfone group. In addition, a commercially available product may be used, and examples thereof include Nafion (manufactured by The Chemours Company), Aquivion (manufactured by Solvay Specialty Polymers Japan K.K.), DIAION (manufactured by Mitsubishi Chemical Corporation), and fumasep (manufactured by FUMATECH BWT GmbH).

An example of the anion exchange resin is a resin having one or more ion exchange groups selected from the group consisting of: a quaternary ammonium group; a primary amino group; a secondary amino group; and a tertiary amino group. A commercially available product may be used, and examples thereof include Sustainion (manufactured by Dioxide Materials), fumasep (manufactured by FUMATECH BWT GmbH), Pention (manufactured by Xergy Inc.), DURION (manufactured by Xergy Inc.), NEOSEPTA (manufactured by ASTOM Corporation), and TOYOPEARL (manufactured by Tosoh Corporation).

From the viewpoint of improving conductivity, the anion exchange resin has a basic site density in a dry state of preferably from 2.0 mmol/cm³ to 5.0 mmol/cm³, more preferably 2.5 mmol/cm³ or more and less than 4.5 mmol/cm³, still more preferably 2.9 mmol/cm³ or more and less than 4.5 mmol/cm³.

The basic site density of the anion exchange resin may be determined from an integral value of signals obtained by performing ¹H NMR measurement of the anion exchange resin.

In addition, the term “dry state” of the anion exchange resin means a state in which the anion exchange resin contains no free water. For example, the anion exchange resin may be brought into a dry state by heating in a vacuum.

When the cathode according to the embodiment of the present disclosure is used in an ion exchange membrane-electrode assembly and a solid electrolyte type electrolysis device to be described later, the same resin as that of the solid electrolyte (ion exchange membrane) is preferably used as the ionomer from the viewpoint of improving conductivity.

The content of the catalyst according to the embodiment of the present disclosure in the catalyst layer is preferably from 50 mass % to 99 mass %, more preferably from 75 mass % to 97 mass %, still more preferably from 90 mass % to 95 mass % from the viewpoint of further improving the electrolysis activity and the reduction reaction speed of CO₂.

### [Gas Diffusion Layer]

For example, the gas diffusion layer includes carbon paper or a nonwoven fabric, or a metal mesh. Examples thereof include graphite carbon, glassy carbon, titanium, and stainless steel (SUS).

### <Ion Exchange Membrane-Electrode Assembly>

An ion exchange membrane-electrode assembly according to an embodiment of the present disclosure includes the above-mentioned cathode according to the embodiment of the present disclosure, a solid electrolyte, and an anode.

The ion exchange membrane-electrode assembly according to the embodiment of the present disclosure includes the cathode including the catalyst produced by the method of producing a catalyst according to the embodiment of the present disclosure, and hence has high electrolysis activity.

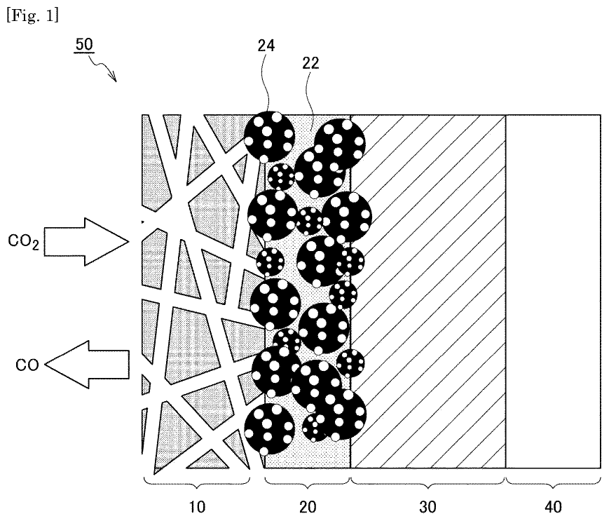

FIG. 1 is a schematic view of an ion exchange membrane-electrode assembly to be suitably used in this embodiment. In FIG. 1, an ion exchange membrane-electrode assembly 50 including a gas diffusion layer 10, a catalyst layer 20, a solid electrolyte 30, and an anode 40 is illustrated. The catalyst layer 20 includes a plurality of catalysts 24 according to the embodiment of the present disclosure and an ionomer 22. A combination of the gas diffusion layer 10 and the catalyst layer 20 forms the cathode according to the embodiment of the present disclosure.

As illustrated in FIG. 1, carbon dioxide (CO₂) is supplied to the catalyst layer 20 through the gas diffusion layer 10, and carbon monoxide (CO) is generated by a reduction reaction.

Description is given below with the reference numerals being omitted in FIG. 1.

### [Solid Electrolyte]

The ion exchange membrane-electrode assembly according to the embodiment of the present disclosure includes a solid electrolyte.

A polymer membrane may be used as the solid electrolyte. Various ionomers may each be used as a polymer. The polymer may be a cation exchange resin or an anion exchange resin, but is preferably an anion exchange resin. That is, the solid electrolyte is preferably an anion exchange membrane. In addition, it is more preferred to use the same anion exchange resin as that of the ionomer to be used in the above-mentioned catalyst layer.

As the solid electrolyte, a product that is commercially available as a cation exchange membrane or an anion exchange membrane may be used.

In addition, when an anion exchange membrane is used as the solid electrolyte, the anion exchange membrane has a basic site density in a dry state of preferably from 0.5 mmol/cm³ to 5.0 mmol/cm³, more preferably 2.5 mmol/cm³ or more and less than 4.5 mmol/cm³, still more preferably 2.9 mmol/cm³ or more and less than 4.5 mmol/cm³.

As the cation exchange membrane, for example, a strongly acidic cation exchange membrane having a sulfone group introduced into a fluororesin base, Nafion 117, Nafion 115, Nafion 212, or Nafion 350 (manufactured by The Chemours Company), a strongly acidic cation exchange membrane having a sulfone group introduced into a styrene-divinylbenzene copolymer base, or NEOSEPTA CSE (manufactured by ASTOM Corporation) may be used.

An example of the anion exchange membrane is an anion exchange membrane having one or more ion exchange groups selected from the group consisting of: a quaternary ammonium group; a primary amino group; a secondary amino group; and a tertiary amino group. Specific examples thereof include: NEOSEPTA (trademark) ASE, AHA, ACS, and AFX (all manufactured by ASTOM Corporation); and SELEMION (trademark) AMVN, DSVN, AAV, ASVN, and AHO (all manufactured by AGC Inc.).

The carbon dioxide reduction reaction, that is, the reduction reaction at the cathode according to the embodiment of the present disclosure varies depending on the kind of the solid electrolyte. When a cation exchange membrane is used as the solid electrolyte, the reduction reactions of the following reaction formula (1) and reaction formula (2) occur, and when an anion exchange membrane is used as the solid electrolyte, the reduction reactions of the following reaction formula (3) and reaction formula (4) occur.

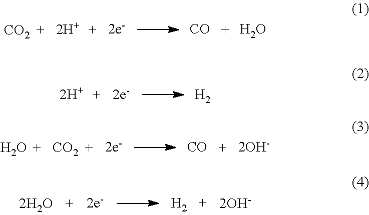

### [Anode]

The oxidation reaction at the anode varies depending on the kind of the solid electrolyte. When a cation exchange membrane is used as the solid electrolyte, the oxidation reaction of the following reaction formula (5) occurs, and when an anion exchange membrane is used as the solid electrolyte, the oxidation reaction of the following reaction formula (6) occurs.

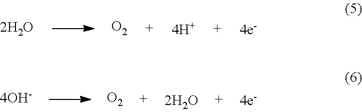

The anode is a gas diffusion electrode including the gas diffusion layer.

For example, the gas diffusion layer includes a metal mesh. Examples of an electrode material for the anode may include Ir, IrO₂, Ru, RuO₂, Co, CoOₓ, Cu, CuOₓ, Fe, FeOₓ, FeOOH, FeMn, Ni, NiOₓ, NiOOH, NiCo, NiCe, NiC, NiFe, NiCeCoCe, NiLa, NiMoFe, NiSn, NiZn, SUS, Au, and Pt.

### <Solid Electrolyte Type Electrolysis Device>

A solid electrolyte type electrolysis device according to an embodiment of the present disclosure includes the above-mentioned cathode according to the embodiment of the present disclosure, an anode forming a pair of electrodes with the cathode, a solid electrolyte interposed between the cathode and the anode in a contact state, and a voltage application unit that applies a voltage between the cathode and the anode.

The solid electrolyte type electrolysis device according to the embodiment of the present disclosure includes the cathode including the catalyst produced by the method of producing a catalyst according to the embodiment of the present disclosure, and hence has high electrolysis activity.

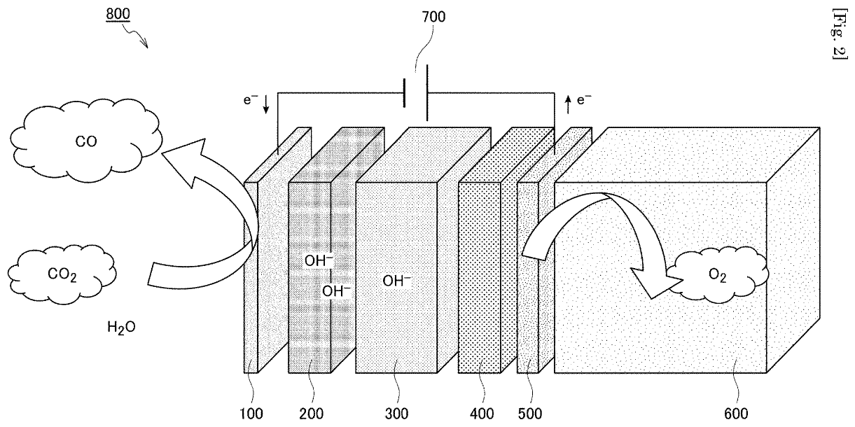

FIG. 2 is a schematic view of a solid electrolyte type electrolysis device to be suitably used in this embodiment.

In FIG. 2, a solid electrolyte type electrolysis device 800 including a cathode 200 according to the embodiment of the present disclosure, an anode 400 forming a pair of electrodes with the cathode 200, a solid electrolyte 300 interposed between the cathode 200 and the anode 400 in a contact state, and a voltage application unit 700 that applies a voltage between the cathode 200 and the anode 400 is illustrated.

The solid electrolyte type electrolysis device 800 illustrated in FIG. 2 further includes a cathode collector plate 100, an anode collector plate 500, and an electrolyte solution 600.

The above-mentioned cathode according to the embodiment of the present disclosure is used as the cathode 200. In addition, the solid electrolyte 300 is the same as the solid electrolyte 30 in FIG. 1, and the solid electrolyte 300 is preferably an anion exchange membrane. The anode 400 is the same as the anode 40 in FIG. 1.

The details of the cathode 200, the solid electrolyte 300, and the anode 400 are as described above.

The respective elements except the cathode 200, the solid electrolyte 300, and the anode 400 are described below with the reference symbols being omitted.

### [Cathode Collector Plate]

Examples of a material for the cathode collector plate include metal materials, such as copper (Cu), nickel (Ni), stainless steel (SUS), nickel-plated steel, and brass. Among them, copper is preferred from the viewpoints of easy workability and cost. When the material for the cathode collector plate is a metal material, the shape thereof is, for example, metal foil, a metal plate, a metal thin film, an expanded metal, a punched metal, or a foam metal.

A gas supply hole for supplying a raw material gas containing carbon dioxide to the cathode and a gas recovery hole for recovering a generated gas containing carbon monoxide may be formed in the cathode collector plate. When the cathode collector plate has the gas supply hole and the gas recovery hole, the raw material gas can be sent to the cathode uniformly and efficiently, and the generated gas (containing an unreacted raw material gas) can be discharged uniformly and efficiently. Only one or two or more gas supply holes and only one or two or more gas recovery holes may be formed independently of each other. In addition, the shape, position, size, and the like of each of the gas supply hole and the gas recovery hole are not limited, and are appropriately set. In addition, when the cathode collector plate has gas permeability, the gas supply hole and the gas recovery hole are not necessarily required.

When the cathode serves to transfer electrons, the cathode collector plate is not necessarily required.

### [Anode Collector Plate]

It is preferred that the anode collector plate have electric conductivity in order to receive electrons from the anode, and have rigidity for supporting the anode. From such viewpoints, a metal material, such as titanium (Ti), copper (Cu), nickel (Ni), stainless steel (SUS), nickel-plated steel, or brass, may be suitably used for the anode collector plate.

A gas flow passage for sending a raw material gas (e.g., H₂O) to the anode may be formed in the anode collector plate. When the anode collector plate has the gas flow passage, a raw material gas can be sent to the anode uniformly and efficiently. The number, shapes, positions, sizes, and the like of the gas flow passages are not limited and are appropriately set.

### [Voltage Application Unit]

The voltage application unit serves to apply a voltage between the cathode and the anode through application of a voltage to the cathode collector plate and the anode collector plate. Here, both the collector plates are conductors, and hence while the voltage application unit supplies electrons to the cathode, the unit receives electrons from the anode. In addition, a control unit (not shown) may be electrically connected to the voltage application unit in order to apply an appropriate voltage.

### [Electrolyte Solution]

The electrolyte solution is preferably an aqueous solution having a pH of 5 or more.

Examples thereof include an aqueous solution of a carbonate, an aqueous solution of a bicarbonate (e.g., aqueous solution of KHCO₃), an aqueous solution of a sulfate, an aqueous solution of a borate, an aqueous solution of sodium hydroxide, an aqueous solution of potassium hydroxide, and an aqueous solution of sodium chloride.

### (Reaction Gas Supply Unit)

In the solid electrolyte type electrolysis device according to the embodiment of the present disclosure, a reaction gas supply unit (not shown) may be arranged on the outside of the solid electrolyte type electrolysis device. That is, it is only required that CO₂ serving as a reaction gas be supplied to the catalyst layer included in the cathode, and the reaction gas may be supplied from the reaction gas supply unit to a gas supply hole through, for example, a pipe (not shown), or the reaction gas supply unit may be arranged so that the reaction gas is blown to the surface of the cathode collector plate on a side opposite to a contact surface with the cathode. In addition, a factory emission gas emitted from a factory is suitably used as the reaction gas from an environmental standpoint.

### [CO Generation Method]

Next, a CO generation method using the solid electrolyte type electrolysis device according to the embodiment of the present disclosure is described.

First, CO₂ that is a reaction gas serving as a raw material is supplied to the solid electrolyte type electrolysis device in a gas phase state by the reaction gas supply unit (not shown). In this case, CO₂ is supplied to the cathode, for example, through the gas supply hole formed in the cathode collector plate.

Next, the CO₂ supplied to the cathode is brought into contact with the catalyst layer of the cathode. As a result, when a cation exchange membrane is used as the solid electrolyte, the reduction reactions of the reaction formula (1) and the reaction formula (2) described above occur, and when an anion exchange membrane is used as the solid electrolyte, the reduction reactions of the reaction formula (3) and the reaction formula (4) described above occur. Thus, a synthesis gas containing at least CO and H₂ is generated.

Next, the generated synthesis gas containing CO and H₂ is sent to a gas recovery device (not shown), for example, through the gas recovery hole formed in the cathode collector plate, and each predetermined gas is recovered.

### EXAMPLES

Next, the technology of the present disclosure is specifically described by way of Examples. However, the technology of the present disclosure is not limited to these examples in any way.

### <Production of Catalyst>

### Example 1

### (Mixing Step (a))

In a beaker, carbon black having a primary particle diameter of 30 nm [VULCAN (XC72) (manufactured by Cabot Corporation)] (0.4 g) serving as a conductive carrier, 4,4′-dimethyl-2,2′-bipyridyl (3.3 mmol) serving as a nitrogen-containing heterocyclic compound (1), and nickel (II) chloride hexahydrate (0.7 mmol) serving as a nickel compound were mixed into 15 mL of ethanol, and the resultant ethanol dispersion liquid was irradiated with ultrasonic waves for 10 minutes. After that, the ethanol dispersion liquid was dried by heating to evaporate ethanol, to thereby provide mixture powder.

The primary particle diameter of the carbon black was determined by laser diffraction particle size distribution measurement.

### (Calcination Step (a))

The resultant mixture powder was calcined by heating at 900° C. for 45 seconds in an inert gas with an electric furnace.

### (Washing Step 1)

The calcined product removed from a quartz tube was dispersed in pure water with a homogenizer and then washed for 3 hours in 2 M sulfuric acid at 80° C. The calcined product was further washed with pure water and then dried.

### (Pulverizing Step)

The calcined product subjected to the washing step 1 was pulverized at 800 rpm for 40 minutes with alumina balls each having a diameter of 0.5 mm.

### (Washing Step 2)

The calcined product subjected to the pulverizing step was dispersed in pure water with a homogenizer and then washed for 3 hours in 2 M sulfuric acid at 80° C. The calcined product was further washed with pure water and then dried to provide a catalyst of Example 1.

### Example 2

A catalyst of Example 2 was produced in the same manner as in the production of the catalyst of Example 1 except that 2,2′-bipyridyl was used as the nitrogen-containing heterocyclic compound (1) instead of 4,4′-dimethyl-2,2′-bipyridyl.

### Example 3

A catalyst of Example 3 was produced in the same manner as in the production of the catalyst of Example 1 except that 1,10-phenanthroline was used as the nitrogen-containing heterocyclic compound (1) instead of 4,4′-dimethyl-2,2′-bipyridyl.

### Example 4

A catalyst of Example 4 was produced in the same manner as in the production of the catalyst of Example 1 except that nickel (II) phthalocyanine (0.7 mmol) was used as a nitrogen-containing heterocyclic compound (2) instead of 4,4′-dimethyl-2,2′-bipyridyl (3.3 mmol) and nickel (II) chloride hexahydrate (0.7 mmol).

### Example 5

A catalyst of Example 5 was produced in the same manner as in the production of the catalyst of Example 1 except that 5,10,15,20-tetraphenyl-21H,23H-porphine nickel (II) (0.7 mmol) was used as a nitrogen-containing heterocyclic compound (2) instead of 4,4′-dimethyl-2,2′-bipyridyl (3.3 mmol) and nickel (II) chloride hexahydrate (0.7 mmol).

### Example 6

A catalyst of Example 6 was produced in the same manner as in the production of the catalyst of Example 1 except that the mixing step (a) was changed to the following mixing step (b).

### (Mixing Step (b))

In a beaker, carbon black having a primary particle diameter of 30 nm [VULCAN (XC72) (manufactured by Cabot Corporation)] (0.4 g) serving as a conductive carrier, 1,10-phenanthroline (0.7 mmol) serving as a nitrogen-containing heterocyclic compound (1), and nickel (II) chloride hexahydrate (0.1 mmol) serving as a nickel compound were mixed into 15 mL of ethanol, and the resultant ethanol dispersion liquid was irradiated with ultrasonic waves for 10 minutes. After that, the ethanol dispersion liquid was dried by heating to evaporate ethanol, to thereby provide mixture powder.

### Example 7

A catalyst of Example 7 was produced in the same manner as in the production of the catalyst of Example 6 except that the calcination step (a) was changed to the following calcination step (b).

### (Calcination Step (b))

The resultant mixture powder was calcined by heating at 900° C. for 30 minutes in an inert gas with an electric furnace.

### Example 8

A catalyst of Example 8 was produced in the same manner as in the production of the catalyst of Example 6 except that the calcination step (a) was changed to the following calcination step (c).

### (Calcination Step (c))

The resultant mixture powder was calcined by heating at 900° C. for 1 hour in an inert gas with an electric furnace.

### Comparative Example 1

A catalyst of Comparative Example 1 was produced in the same manner as in the production of the catalyst of Example 1 except that the mixing step (a) was changed to the following mixing step (c).

### (Mixing Step (c))

In a beaker, carbon black having a primary particle diameter of 30 nm [VULCAN (XC72) (manufactured by Cabot Corporation)] (0.4 g) serving as a conductive carrier, pentaethylenehexamine (1.1 mmol) serving as a nitrogen-containing compound for comparison, and nickel (II) chloride hexahydrate (0.7 mmol) serving as a nickel compound were mixed into 15 mL of ethanol, and the resultant ethanol dispersion liquid was irradiated with ultrasonic waves for 10 minutes. After that, the ethanol dispersion liquid was dried by heating to evaporate ethanol, to thereby provide mixture powder.

### Comparative Example 2

A catalyst of Comparative Example 2 was produced in the same manner as in the production of the catalyst of Example 1 except that ethylenediamine was used as the nitrogen-containing compound for comparison instead of 4,4′-dimethyl-2,2′-bipyridyl.

### Comparative Example 3

A catalyst of Comparative Example 3 was produced in the same manner as in the production of the catalyst of Example 1 except that the mixing step (a) was changed to the following mixing step (d).

### (Mixing Step (d))

In a beaker, carbon black having a primary particle diameter of 30 nm [VULCAN (XC72) (manufactured by Cabot Corporation)] (0.4 g) serving as a conductive carrier, pentaethylenehexamine (0.2 mmol) serving as a nitrogen-containing compound for comparison, and nickel (II) chloride hexahydrate (0.1 mmol) serving as a nickel compound were mixed into 15 mL of ethanol, and the resultant ethanol dispersion liquid was irradiated with ultrasonic waves for 10 minutes. After that, the ethanol dispersion liquid was dried by heating to evaporate ethanol, to thereby provide mixture powder.

### Comparative Example 4

A catalyst of Comparative Example 4 was produced in the same manner as in the production of the catalyst of Example 6 except that the calcination step (a) was changed to the following calcination step (d).

### (Calcination Step (d))

The resultant mixture powder was calcined by heating at 600° C. for 2 hours in an inert gas with an electric furnace.

### Comparative Example 5

A catalyst of Comparative Example 5 was produced in the same manner as in the production of the catalyst of Example 6 except that the calcination step (a) was changed to the following calcination step (e).

### (Calcination Step (e))

The resultant mixture powder was calcined by heating at 900° C. for 1.5 hours in an inert gas with an electric furnace.

The calcination conditions (calcination temperature and calcination time) for the catalyst produced in each of Examples 1 to 8 and Comparative Examples 1 to 5, and the loading amount (Ni/C) [atom ‰] of nickel with respect to the carbon-containing carrier are shown in Table 1.

### <Evaluation of Catalyst>

The composition ratio (Ni/C) of a nickel ion bonded to (coordinated by) a nitrogen atom to carbon in the catalyst was measured by X-ray photoelectron spectroscopy (XPS). Narrow scan measurement was performed for each element with an XPS measurement device (AXIS Ultra DLD, manufactured by Kratos Analytical, Ltd.), and the composition ratio was determined from the area of each peak.

From the measurement results, the content of the nickel ion coordinated by the nitrogen atom was calculated, and the supported amount (Ni/C) [atom ‰] of nickel (Ni) with respect to the carbon-containing carrier (C) was calculated.

The Ni supported amount (Ni/C) [atom ‰] is shown in Table 1.

The allowable range of the Ni supported amount (Ni/C) is 2.3 [atom % 0] or more.

TABLE 1

| | | Ni loading | | | | |
|---|---|---|---|---|---|---|
| | | amount | Calcination | | | Ni supported |
| | Nitrogen-containing | Ni/C | conditions | | | amount Ni/C |
| | compound | [atom ‰] | Temperature | Time | | [atom ‰] |
| Example 1 | 4,4′-Dimethyl-2,2′- | 22 | 900° C. | 45 | s | 2.9 |
| | bipyridyl | | | | | |
| Example 2 | 2,2′-Bipyridyl | 22 | 900° C. | 45 | s | 2.5 |
| Example 3 | 1,10-Phenanthroline | 22 | 900° C. | 45 | s | 8.0 |
| Example 4 | Nickel(II) | 22 | 900° C. | 45 | s | 8.4 |
| | phthalocyanine | | | | | |
| Example 5 | 5,10,15,20- | 22 | 900° C. | 45 | s | 10.9 |
| | Tetraphenyl-21H,23H- | | | | | |
| | porphine nickel(II) | | | | | |
| Example 6 | 1,10-Phenanthroline | 4.4 | 900° C. | 45 | s | 2.7 |
| Example 7 | 1,10-Phenanthroline | 4.4 | 900° C. | 30 | min | 2.7 |
| Example 8 | 1,10-Phenanthroline | 4.4 | 900° C. | 1 | h | 2.4 |
| Comparative | Pentaethylenehexamine | 22 | 900° C. | 45 | s | 1.1 |
| Example 1 | | | | | | |
| Comparative | Ethylenediamine | 22 | 900° C. | 45 | s | trace |
| Example 2 | | | | | | |
| Comparative | Pentaethylenehexamine | 4.4 | 900° C. | 45 | s | 0.5 |
| Example 3 | | | | | | |
| Comparative | 1,10-Phenanthroline | 4.4 | 600° C. | 2 | h | 1.9 |
| Example 4 | | | | | | |
| Comparative | 1,10-Phenanthroline | 4.4 | 900° C. | 1.5 | h | 2.1 |

Example 5

As is understood from Table 1, the catalysts of Examples each produced by obtaining a mixture through use of the nitrogen-containing heterocyclic compound (1) or (2) following the mixing step according to the embodiment of the present disclosure and by calcining the mixture following the calcination step according to the embodiment of the present disclosure each had a larger supported amount of non-aggregated nickel on the carrier than those of the catalysts of Comparative Examples.

In contrast, the catalysts of Comparative Examples 1 to 3 each produced without using the nitrogen-containing heterocyclic compound according to the embodiment of the present disclosure, and the catalysts of Comparative Examples 4 and 5 each produced by using the nitrogen-containing heterocyclic compound according to the embodiment of the present disclosure but without following the calcination step according to the embodiment of the present disclosure each had a Ni supported amount (Ni/C) of less than 2.1 [atom ‰].

The term “trace” of Comparative Example 2 in Table 1 means that the supported amount was equal to or less than the detection limit of an analysis device and was difficult to quantify.

<Manufacture of Solid Electrolyte Type Electrolysis Device>

### Example 3

The catalyst of Example 3 was added to ethanol and dispersed therein. Further, “Nafion (trademark)” (cation exchange resin) manufactured by Sigma-Aldrich Japan K.K. was added as an ionomer to provide a catalyst dispersion liquid containing an ionomer. The catalyst dispersion liquid was applied onto carbon paper to provide a cathode. The cathode includes the applied film of the catalyst dispersion liquid as a catalyst layer and the carbon paper as a gas diffusion layer.

An anion exchange membrane having a thickness of about 30 μm (basic site density: 2.8 mmol/cm³) and an anode produced by causing iridium oxide to be supported on a titanium mesh (manufactured by Taiyo Wire Cloth Co., Ltd., opening ratio: 56%) were bonded to the resultant cathode to provide an ion exchange membrane-electrode assembly.

The anode was formed into a structure in contact with an electrolyte solution (0.5 mol/L KHCO₃ aqueous solution) tank.

### Examples 6 and 7 and Comparative Examples 1 to 4

Solid electrolyte type electrolysis devices of Examples 6 and 7 and Comparative Examples 1 to 4 were each manufactured in the same manner as in the manufacture of the solid electrolyte type electrolysis device of Example 3 except that the catalyst was changed from the catalyst of Example 3 to each of the catalysts of Examples 6 and 7 and Comparative Examples 1 to 4.

### <Evaluation of Solid Electrolyte Type Electrolysis Device>

### Examples 3, 6, and 7 and Comparative Examples 1 to 4

CO₂ was electrolyzed by using each of the solid electrolyte type electrolysis devices of Examples 3, 6, and 7 and Comparative Examples 1 to 4, supplying pure CO₂ at a flow rate of 100 sccm to the cathode, and setting the application potential of the cathode to −1.8 V with respect to a silver/silver chloride reference electrode. The current density [mA/cm²] at the time of the generation of CO and the CO selectivity [%] were measured.

The results are shown in Table 2.

For reference, the nitrogen-containing compound, the calcination conditions, and the Ni supported amount shown in Table 1 are also shown in Table 2.

TABLE 2

| | | | | | Ni | | |
|---|---|---|---|---|---|---|---|
| | | | | | supported | | |
| | | Calcination | | | amount | Current | CO |
| | Nitrogen-containing | conditions | | | Ni/C | density | selectivity |
| | compound | Temperature | Time | | [atom ‰] | [mA/cm²] | [%] |
| Example 3 | 1,10-Phenanthroline | 900° C. | 45 | s | 8.0 | 240 | 96 |
| Example 6 | 1,10-Phenanthroline | 900° C. | 45 | s | 2.7 | 260 | 98 |
| Example 7 | 1,10-Phenanthroline | 900° C. | 30 | min | 2.7 | 255 | 99 |
| Comparative | Pentaethylenehexamine | 900° C. | 45 | s | 1.1 | 230 | 99 |
| Example 1 | | | | | | | |
| Comparative | Ethylenediamine | 900° C. | 45 | s | trace | 110 | 98 |
| Example 2 | | | | | | | |
| Comparative | Pentaethylenehexamine | 900° C. | 45 | s | 0.5 | 190 | 99 |
| Example 3 | | | | | | | |
| Comparative | 1,10-Phenanthroline | 600° C. | 2 | h | 1.9 | 210 | 98 |

Example 4

As is understood from Table 2, the solid electrolyte type electrolysis devices manufactured by using the catalysts of Examples 3, 6, and 7, each having a large amount of the catalyst source supported on the carrier, each have a large current density and high electrolysis activity as compared to the solid electrolyte type electrolysis devices of Comparative Examples 1 to 4.

### INDUSTRIAL APPLICABILITY

According to this embodiment, a synthesis gas containing at least CO and H₂ at a desired generation ratio can be generated by using a CO₂ gas emitted from a factory as a raw material and by using renewable energy of a solar cell or the like to a voltage application unit for a solid electrolyte type electrolysis device. The synthesis gas generated as described above can generate a fuel base material, a chemical raw material, or the like by a method, such as Fischer-Tropsch synthesis (FT synthesis) or methanation.

### REFERENCE SIGNS LIST

10 gas diffusion layer
20 catalyst layer
22 ionomer
24 catalyst
30 solid electrolyte (ion exchange membrane)
40 anode
50 ion exchange membrane-electrode assembly
100 cathode collector plate
200 cathode
300 solid electrolyte (ion exchange membrane)
400 anode
500 anode collector plate
600 electrolyte solution
700 voltage application unit
800 solid electrolyte type electrolysis device

1. A method of producing a catalyst for producing an electrode catalyst comprising a nitrogen-containing carbon material, comprising:
a mixing step of mixing a carbon-containing carrier, a nickel compound, and a nitrogen-containing compound comprising 1 to 6 heterocycles each having 5 to 14 ring-forming atoms and at least two nitrogen atoms; and
a calcination step of calcining the mixture obtained in the mixing step for a calcination time of 10 seconds or more and 1 hour or less.

2. A method of producing a catalyst for producing an electrode catalyst comprising a nitrogen-containing carbon material, comprising:
a mixing step of mixing a carbon-containing carrier, and a nitrogen-containing compound comprising 1 to 6 heterocycles each having 5 to 14 ring-forming atoms, at least two nitrogen atoms, and a nickel ion; and
a calcination step of calcining the mixture obtained in the mixing step for a calcination time of 10 seconds or more and 1 hour or less.

3. The method of producing a catalyst according to claim 1, wherein the calcination step comprises calcining the mixture at 750° C. or more and less than 1,000° C.

4. The method of producing a catalyst according to claim 1, wherein the nitrogen-containing compound comprises a pyridine ring, a pyrrole ring, or an isoindole ring.

5. The method of producing a catalyst according to claim 1, wherein the calcination time is 30 minutes or less.

6. The method of producing a catalyst according to claim 1, wherein the calcination time is 1 minute or less.

7. A cathode, comprising: a catalyst layer comprising an electrode catalyst produced by the method of producing a catalyst of claim 1; and a gas diffusion layer.

8. An ion exchange membrane-electrode assembly, comprising the cathode of claim 7, a solid electrolyte, and an anode.

9. The ion exchange membrane-electrode assembly according to claim 8, wherein the solid electrolyte is an anion exchange membrane.

10. A solid electrolyte type electrolysis device, comprising:
the cathode of claim 7;
an anode forming a pair of electrodes with the cathode;
a solid electrolyte interposed between the cathode and the anode in a contact state; and
a voltage application unit configured to apply a voltage between the cathode and the anode.

11. The solid electrolyte type electrolysis device according to claim 10, wherein the solid electrolyte is an anion exchange membrane.
